(19) United States
(12) Patent Application Publication
(10) Pub. No.: US 2011/0280179 A1
(43) Pub. Date: Nov. 17, 2011

(54) Method And Apparatus For Access Selection In A Communication Network

(76) Inventor: Joachim Sachs, Aachen (DE)

(21) Appl. No.: 12/674,526

(22) PCT Filed: Dec. 20, 2007
(86) PCT No.: PCT/EP07/11257

§ 371 Date: Jun. 13, 2011

(30) Foreign Application Priority Data
Aug. 21, 2007 (EP) EP2007/058691

(51) Int. Cl. H04W 4/00

(52) U.S. Cl. 370/328

(57) ABSTRACT

The invention relates to a method for selecting (302) a radio access network (101; 102; 103) for establishing a radio connection for connecting a mobile terminal (1 1) to a communication network (105) wherein the mobile terminal (1 1) is connectable to the communication network (105) through a plurality of access networks (101; 102; 103). The method comprises the following steps: predetermining for one or more of the access networks a corresponding likelihood value indicating a likelihood of successfully connecting the mobile terminal to the respective access network with respect to a reference area (301), and selecting a radio access network for connecting the mobile terminal using the predetermined likelihood values (302).

### TECHNICAL FIELD

The invention relates to the field of telecommunication. In particular the invention relates to a method and apparatus for selecting a radio access network for connecting a mobile terminal to a communication network

### BACKGROUND

The recent evolution of mobile networks has lead to co-existence of multiple access networks of different type at a given location of a mobile terminal. If these multiple access networks are connectable to a communication network, a mobile terminal capable of the multiple access technologies is connectable to the communication network using the multiple access networks. A mobile terminal can also be a user network consisting of a number of devices. The connection can be to a peer terminal or any kind of peer node communicating with the mobile terminal. The different access networks can be operated by different network operators or multiple access networks can be operated by a single network operator.

Examples for access networks according to the various access technologies are a GSM (Global System for Mobile communication) access network, a GPRS (General Packet Radio Service) access network, an enhanced GPRS access network, a UMTS (Universal Mobile Telecommunication System) access network, an HSPA (High Speed Packet Access) access network, an evolved HSPA access network, an LTE (Long-Term-Evolution) access network a W-LAN (Wireless Local Area Network), an network according to the IEEE (Institute of Electrical and Electronics Engineers) 802.16 specification, which is often referred to as WiMAX (Worldwide Interoperability for Microwave Access), but also others.

According to 3GPP (3^{rd} Generation Partnership Program) specifications reference points are defined for integrating one or more of the access networks, i.e. providing means for selecting one among the plurality of access networks.

In a communication system, that provides access to a mobile terminal using a plurality of access networks, the problem exists to select a specific one of the access networks to actually provide access to the communication system for the mobile terminal.

### SUMMARY

It is object of the invention to provide a method and an apparatus that address this problem.

According to the present invention a method for selecting a radio access network for establishing a radio connection for connecting a mobile terminal to a communication network is provided wherein the mobile terminal is connectable to the communication network through a plurality of access networks. The method proposed method comprises the following steps:

predetermining for one or more of the access networks a corresponding likelihood value indicating a likelihood of successfully connecting the mobile terminal to the respective access network with respect to a reference area, and selecting a radio access network for connecting the mobile terminal using the predetermined likelihood values.

Preferably the reference area comprises the location where the mobile terminal is currently located.

According to a particular embodiment of the invention different radio access technologies are applied within the different radio access networks.

By this a radio access network having the most appropriate radio access technology can be predetermined depending on the current location of the mobile terminal.

According to a preferred embodiment of the invention the one or more likelihood values correspond to a respective area size of an area interior to the reference area within which interior area the terminal can be successfully connected.

This parameter can be obtained simply by measurement reports comprising current location information.

According to a further preferred embodiment the step of selecting the radio access network depends on evaluating a recorded mobility pattern of the mobile terminal.

By this the access selection method can be optimised for the mobile terminal and adapted individually for the mobile terminal.

According to another preferred embodiment the reference area is determined based on the recorded mobility pattern of the mobile terminal.

By this the access selection method can be optimised for the mobile terminal and adapted individually for the mobile terminal.

According to a further preferred embodiment the reference area is divided into a plurality of subareas, and wherein the likelihood of providing access is a weighted likelihood with contributions from the plurality of subareas.

By this the relevance of a subarea can be controlled according to a presumed importance for the user of the mobile terminal.

According to another preferred embodiment of the invention the subareas are considered depending on the recorded mobility pattern of the mobile terminal.

By this the relevance of a subarea can be controlled according to a likelihood of the mobile terminal visiting the subarea.

According to a specific embodiment the subareas are considered depending on their signal quality.

According to yet another preferred embodiment the predetermined likelihood is used for the radio access network selection in combination with at least one further criterion comprising an expected link quality, a cell load, a radio resource efficiency, and a priority of a respective one of the plurality of access networks.

By this the access selection method can balance aspects of quality experience and resource usage against each other.

According to another preferred embodiment the criteria are combined using for each criterion a corresponding weight.

According to a further preferred embodiment the weight corresponding to the likelihood of successfully connecting the terminal is determined depending on an application or service utilizing the radio connection to be established.

By this the tolerance of an application to connectivity losses can be taken into account in the access selection method.

According to another preferred embodiment the weight corresponding to the likelihood of successfully connecting the mobile terminal is determined depending on the recorded mobility pattern of the user.

By this the access selection method can be optimised for the mobile terminal and adapted individually for the mobile terminal.

According to yet a further preferred embodiment the likelihood of successfully connecting the terminal is determined using a measurement report of a further mobile terminal within the reference area.

By this the access selection method can be optimised regarding radio conditions where the mobile terminal has not previously been located.

According to a further aspect of the invention a network node for controlling the selection of a radio access network for establishing a radio connection for connecting a mobile terminal to a communication network wherein the mobile terminal is connectable to the communication network through a plurality of access networks. The control node comprises a processing unit for determining for one or more of the access networks a corresponding likelihood value indicating a likelihood of successfully connecting the mobile terminal to the respective access network with respect to a reference area, and the control node further comprises a control unit for controlling the selection of a radio access network for connecting the mobile terminal using the predetermined likelihood values.

The Control node is susceptible to corresponding advantageous modifications as the methods provided in accordance with the teachings of the present invention.

### BRIEF DESCRIPTION OF THE DRAWINGS

The following figures show:

FIG. 1 is a block diagram illustrating a communication network for access selection in accordance with the teachings of the present invention.

FIG. 2 is a signal sequence diagram for illustrating a sequence of signals exchanged between elements of the network of FIG. 1 to perform an access selection in accordance with the teachings of the present invention.

FIG. 3 is a flow chart diagram for illustrating a method of access selection in accordance with the teachings of the present invention.

FIG. 4 is a block diagram illustrating an access selection module in accordance with the teachings of the present invention.

FIG. 5 is a block diagram illustrating a mobile terminal in accordance with the teachings of the present invention.

### DETAILED DESCRIPTION

In the following the invention is described in more detail by means of embodiments and figures. Equal reference signs indicate equal elements.

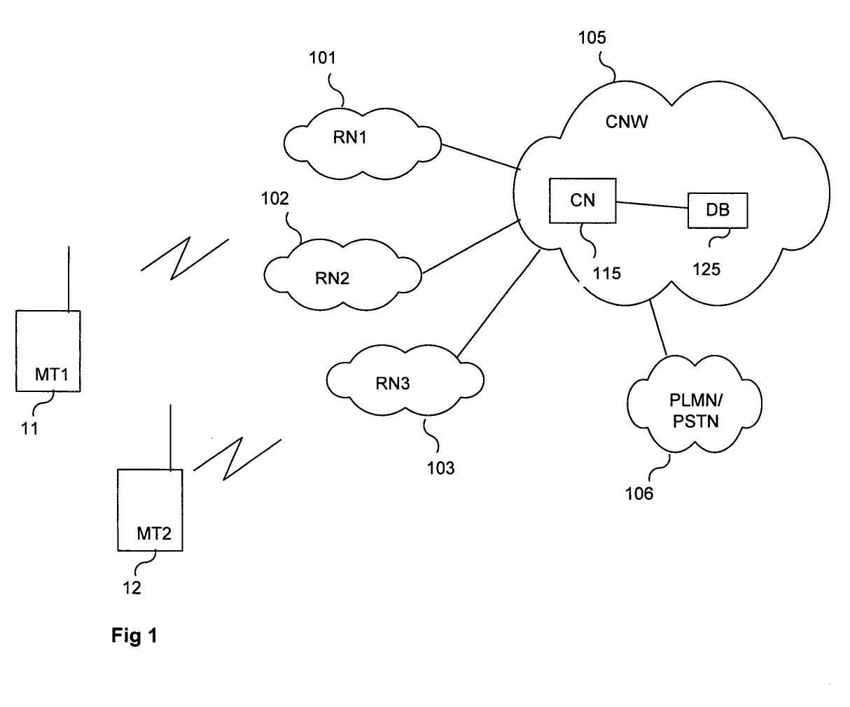

FIG. 1 depicts a communication network for access selection according to the teachings of the present invention. FIG. 1 also depicts a first and a further mobile terminal 11 and 12 connectable to the communication network using a first, second and third radio access network 101, 102 and 103. It should be noted that three access networks are described here merely as an example and that the invention is not limited to the selection among a particular number of access networks as long as there are at least two radio access networks to select from. Different radio access technologies may be applied within the different radio access networks. As an example the first radio access network 101 can be a UMTS radio access network, the second radio access network 102 can be an LTE access network and the third radio access network 103 can be a WiMAX network. However it should be noted that the various radio access networks can be of any kind of access technology suitable for connecting a mobile device.

The first and the further mobile terminal 11 and 12 are equipped with radio interfaces for being connected via the first, the second and the third radio access network 101, 102, or 103 to a communication network 105. The communication network 105 is further connected to a further network 106 that may be embodied as a fixed network or as a further mobile network.

In the context of the present application the term ‘mobile terminal’ is meant to include also a composition of devices interconnected to each other either via one or more wireline connections or via one or more short range radio connections such as Bluetooth connections known in the state of the art, wherein at least one of the devices comprises a radio interface towards a radio access network. Within the context of the present invention at least two different radio access technologies should be accessible via the devices. In the case of a short range radio connectivity the composition of devices described above is sometimes referred to as a ‘user network’ or a ‘personal area network’.

The communication network 105 comprises a control node 115 for controlling a decision for selecting one or more of the radio access networks for connecting the mobile terminal 11 to the communication network. In another embodiment of the invention the control over the decision to select the one or more radio access networks for connecting the mobile terminal could be in the terminal e.g. in one of the devices of the ‘user network’.

To that end the control node 115 has access to control data comprising data for defining a reference area and data for determining for each of the radio access networks 101, 102, and 103 likelihood value indicating a likelihood of successfully connecting a mobile terminal to the respective radio access network when the mobile terminal roams within the defined reference area.

As an example data for defining a reference area can be a list of identifications of location areas defined for the radio access networks 101, 102, and 103. Alternatively a reference area may be defined using a traverse of coordinates of boundary point. In this case the data for defining the reference area may be a list of the boundary point coordinates.

The control node 115 also has access to data defining for each of the radio access networks 101, 102, and 103 a likelihood of successfully connecting a mobile terminal equipped with the appropriate radio technology to a respective one of the radio access networks. The term connecting as used within the context of the present application is meant to embrace establishing a connection and staying connected i.e. keeping a previously established connection alive.

The likelihood value may be expressed as a part of the reference area within which an appropriately equipped mobile terminal can be connected to the mobile network.

To collect data from that the respective likelihood values are obtainable a database 125 can be provided within the communication network 105.

The database 125 is capable of collecting measurement reports from mobile terminals including the first and the further mobile terminal 11 and 12, that comprise location coordinates of current or previous locations together with information indicating whether the respective mobile terminal could successfully connect to one of the radio access networks or not. Location information can be obtained either using the cellular structure of the coverage area of the respective radio access network, e.g. location areas for a GSM network, or be obtained using a further network independent location information, i.e. location information obtained using a location technology that is independent from any radio access network such as GPS (Global Positioning System) and its successors. Alternatively location information form the radio access networks can be combined with each other or combined with the network independent location information.

Advantageously the measurement reports include in addition an indication of the connection quality provided within the respective mobile network.

Measurement reports indicating that at a particular location connectivity could not be provided for the mobile terminal 11 or 12 by a certain radio access network, can either be provided using a different radio access network or be recorded at the mobile terminal and provided to the database when connectivity can again be provided to the certain radio access network.

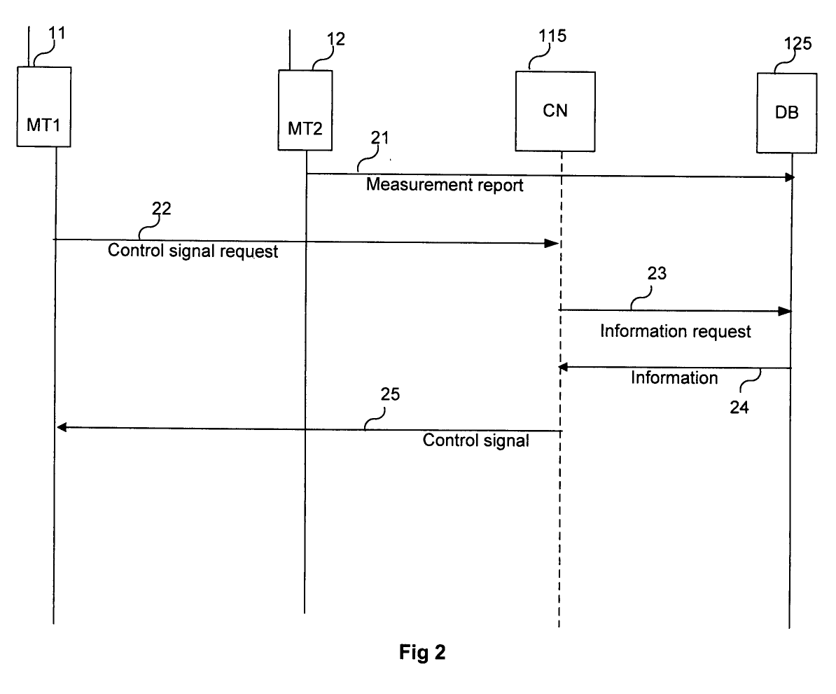

FIG. 2 depicts a sequence of signals exchanged between first mobile terminal 11, the control node 115, the database 125, and the further mobile terminal 12 depicted in FIG. 1. Signal 21 represents a measurement report from the further mobile terminal 12 to the database 125. The measurement report comprises data indicating a current or previous location of the mobile terminal 12 or alternatively a list comprising previous locations or a list comprising a current and also previous locations of the mobile terminal 12. The location data can be obtained using either location information from one or more of the radio access networks or using further technology for obtaining location information or using a combination of both as described above in relation to FIG. 1. In a addition the measurement report comprises an indication whether connectivity could be provided at an associated location, which is advantageously complemented with a corresponding signal quality measurement.

Preferably the further mobile station is one of a plurality of mobile stations that provide measurement reports, so that a particular of the mobile stations aiming to select a radio access network or requesting an access selection decision can benefit from measurements that are not limited by the area where the particular mobile station is or has been roaming.

Signal 22 represents a request of the first mobile terminal 11 to the control node 115 to provide control regarding a selection of an radio access network for connecting the first mobile terminal 11 to the communication network 105, which is depicted in FIG. 1.

To obtain data necessary for the access network selection, the control node may either be preconfigured with the necessary data, or, alternatively, the data necessary for the decision can be obtained form the measurement reports collected in the database 125.

In the latter case the control node sends a request 23 for the information form the measurement reports to the database 115, which answers with a response 14 comprising the data from the measurement reports, that may have been pre-processed within the database 125.

In any case data necessary for the access selection includes data indicating for each of the radio access networks 101,102, and 103 a corresponding likelihood of successfully connecting the mobile terminal to the communication network using that particular access network.

The access selection method can utilize data from the measurement reports in various ways. As an example the reference area can be apportioned in to subareas that are considered areas where connectivity can be provided to a mobile terminal by a particular radio access network and subareas that are considered areas where connectivity can not be provided by the particular radio access network. In this example the likelihood of successfully connecting the mobile terminal corresponds to the area size of the subarea interior to the reference area where connectivity can be provided.

Also the reference area for a mobile terminal can be determined based on a measurement report from the respective mobile terminal, i.e. the reference area can be an area in that the mobile terminal has been roaming frequently.

To that end a recorded mobility pattern of the respective mobile terminal can be used.

The reference area may be divided into subareas, and the likelihood of providing access can be a weighted likelihood with contributions from the plurality of subareas. As an example the weights can be determined using the recorded mobility patterns and subareas where the mobile terminal has been located more frequently can be associated with a correspondingly higher weight.

The predetermined likelihood can be used in combination with other parameters influencing the access network selection, such as an expected link quality, a cell load, a radio resource efficiency, or a priority of a respective one of the plurality of access networks.

The parameters influencing the radio access network selection can be combined using for each criterion a corresponding weight. The weight associated with the likelihood of successfully connecting the terminal can be for example determined depending on an application or service utilizing the radio connection to be established. As an example, for an application that is more sensitive to a connection loss, such as a speech or video application, the likelihood of providing access is particularly relevant an the weight should reflect this. On the other hand, for an application that is less sensitive to a connectivity loss such as an FTP (file transfer protocol) application, the likelihood of providing access is less relevant an the weight associated with the likelihood of providing access can reflect that as well.

The weight associated with the likelihood of successfully connecting the mobile terminal can further depend on the recorded mobility pattern of the user. As an example, for a user of a mobile terminal that is moving less often the likelihood of successfully connecting the mobile terminal is probably less important than the actual connection quality and the likelihood of successfully connecting the mobile terminal can be associated with a correspondingly lower weight factor.

Measurement reports considered in the access selection for a particular mobile terminal are not limited to measurement reports from the mobile station to be connected.

Measurement reports from a plurality of mobile terminals can be evaluated and combined in the data base 125 to obtain data on where connectivity can be provided and to obtain likelihood values of successfully connecting a mobile terminal with respect to a reference area.

Continuing with the signal flow of FIG. 2, the control node 115 sends a control signal 25 to the mobile station to control the access selection decision for the first mobile terminal 11.

This means the control node 115 can either control a decision in the mobile terminal 11 and provide necessary information for the access selection decision to the mobile terminal using the control signal 25 or the control node can select an access network for connecting the first mobile terminal 11 and instruct the first mobile terminal 11 to attach to a selected radio access network using control signal 25.

Finally the first mobile station establishes a connection to the communication network 125 using the selected radio access network.

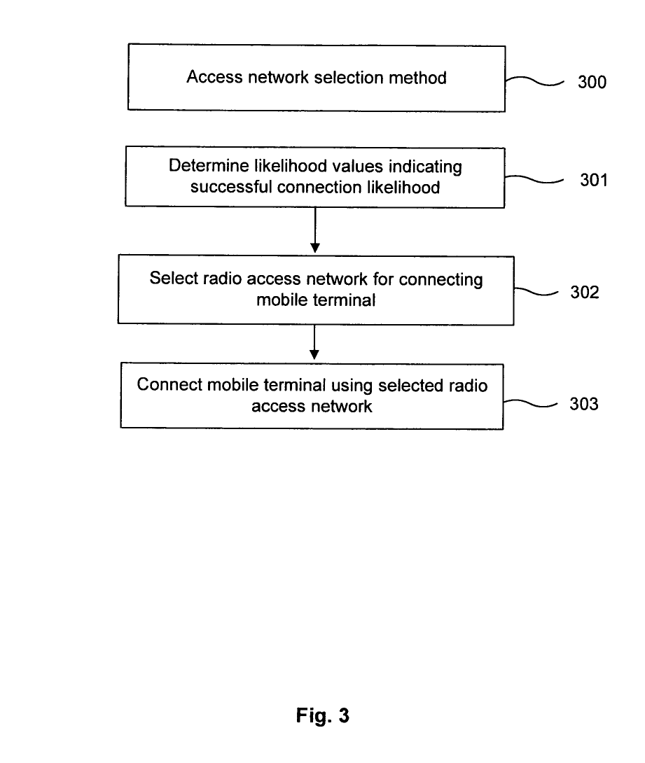

FIG. 3 depicts a sequence of processing steps of a method of access selection in accordance with the teachings of the present invention.

The method 300 of FIG. 3 is suitable for selecting an access network in a scenario like in FIG. 1, where a mobile terminal is connectable to a communication network through a plurality of access networks.

Starting with processing step 301 likelihood values are determined for one or more of the access networks, indicating a likelihood of successfully connecting the mobile terminal to the respective access network with respect to a reference area.

Continuing with processing step 302 a radio access network for connecting the mobile terminal is selected using the predetermined likelihood values.

Continuing with processing step 303 a radio connection for connecting the mobile terminal to a communication network is established using the selected radio access network.

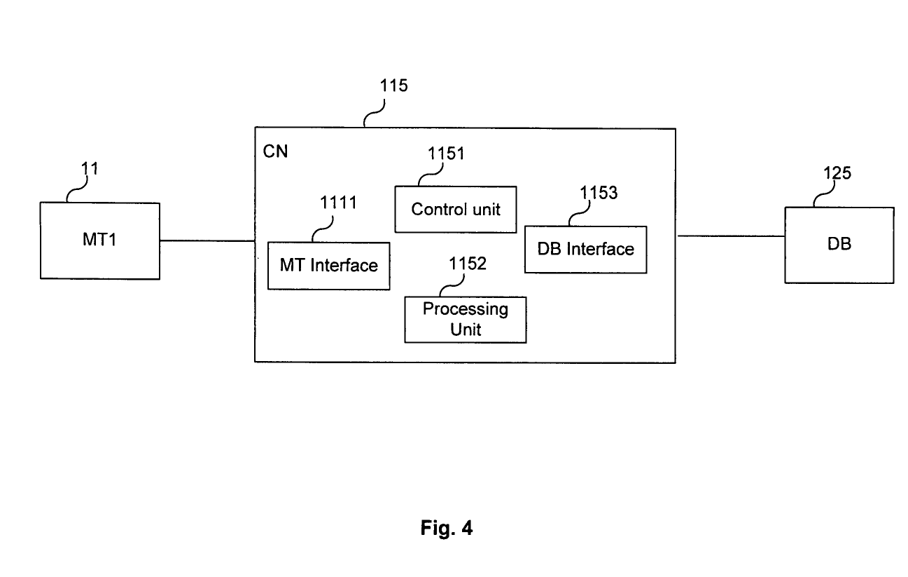

FIG. 4 depicts an implementation of a control node 115 of FIG. 1. The control node is connectable to mobile terminal 11 using a radio connection as described also in FIG. 1. Furthermore the control node is connectable to the database 125 depicted in FIG. 1 using a database interface 1153.

The control node 115 is adapted to perform at least some of the steps of the access selection decision depicted in FIG. 2. To that end the control node comprises a processing unit 1152 for determining for one or more of the access networks a corresponding likelihood value indicating a likelihood of successfully connecting the mobile terminal to the respective access network with respect to a reference area. To obtain likelihood value information from the data base 125 that has been received via the data base interface 1153 can be used.

The control node further comprises a control unit 1151 for controlling the selection of a radio access network for connecting the mobile terminal using the predetermined likelihood values

This means the control unit 1151 can either control a decision in the mobile terminal 11 and provide necessary information for the access selection decision to the mobile terminal using the control signal send via the control interface 1111 or the control node can select an access network for connecting the first mobile terminal 11 and instruct the mobile terminal 11 to attach to a selected radio access network using a control signal sent via the control interface 1111.

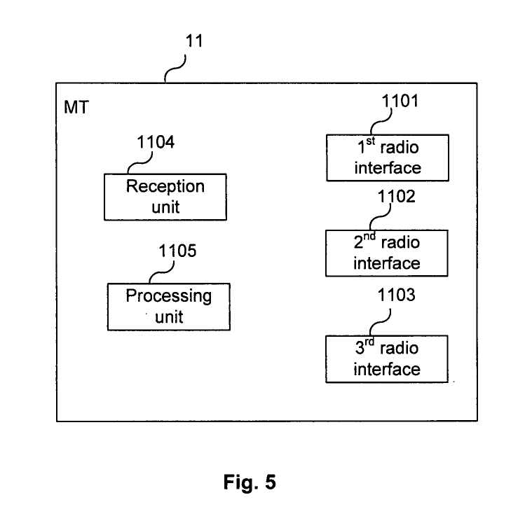

FIG. 5 depicts an implementation example of a mobile terminal 11 of FIG. 1. The mobile terminal comprises a first, a second, and a third radio interface 1101, 1102, and 1103 providing access to respective radio access networks 101-103 depicted in FIG. 1. However it should be understood that the application is not limited to a specific number of radio interfaces.

Furthermore the mobile terminal 11 comprises a reception unit 1104 for receiving control information comprising for one or more of the access networks a corresponding likelihood value indicating a likelihood of successfully connecting the mobile terminal to the respective access network with respect to a reference area.

In addition the mobile terminal 11 comprises a processing unit for selecting a radio access network and a corresponding one of the radio interfaces 1101-1103 for connecting the mobile terminal. To that end the processing unit 1105 is adapted to use the control information received in the processing unit 1105.

A mobile terminal as defined in this application can consist of a single device including multiple modules, e.g. relating to the interfaces and/or units, or it can consist of a number separate interconnected devices which contain the modules. The interconnection between devices can be achieved via fixed connections (e.g. USB, PCMCIA) or wireless connections (e.g. Bluetooth, ultra-wide band, IEEE 802.15).

As explained above the term mobile terminal is meant in the present application to include also personal area networks or user networks, i.e. a composition of mobile devices interconnected to each other. Therefore the processing unit 1105, the reception unit 1104 and the radio interfaces 1101-1103 may be implemented, at least partly, on different devices interconnected to each other using a short range radio technology.

1. Method for selecting (302) a radio access network (101; 102; 103) for establishing a radio connection for connecting a mobile terminal (11) to a communication network (105) wherein the mobile terminal (11) is connectable to the communication network (105) through a plurality of access networks (101; 102; 103), the method comprising the following steps:
predetermining for one or more of the access networks a corresponding likelihood value indicating a likelihood of successfully connecting the mobile terminal to the respective access network with respect to a reference area (301), and selecting a radio access network for connecting the mobile terminal using the predetermined likelihood values (302).

2. Method according to claim 1, wherein different radio access technologies are applied within the different radio access networks.

3. Method according to any of the preceding claims, wherein the one or more likelihood values correspond to a respective area size of an area interior to the reference area within which interior area the terminal can be successfully connected.

4. Method according to any of the preceding claims, wherein the step of selecting the radio access network depends on evaluating an expected or a recorded mobility pattern of the mobile terminal.

5. Method according to claim 4, wherein the reference area is determined based on the expected or recorded mobility pattern of the mobile terminal.

6. Method according to any of the preceding claims, wherein the reference area is divided into a plurality of subareas, and wherein the likelihood of providing access is a weighted likelihood with contributions from the plurality of subareas.

7. Method according to any of the claims 4 and 6, wherein the subareas are considered depending on the expected or recorded mobility pattern of the mobile terminal.

8. Method according to claim 7, wherein the subareas are considered depending on their signal quality.

9. Method according to any of the preceding claims, wherein the predetermined likelihood is used for the radio access network selection in combination with at least one further criterion comprising an expected link quality, a cell load, a radio resource efficiency, and a priority of a respective one of the plurality of access networks.

10. Method according to claim 9, wherein the criteria are combined using for each criterion a corresponding weight.

11. Method according to claim 10, wherein the weight corresponding to the likelihood of successfully connecting the mobile terminal is determined depending on an application or service utilizing the radio connection to be established.

12. Method according to claim 4 and any of the claims 10 and 11, wherein the weight corresponding to the likelihood of successfully connecting the mobile terminal is determined depending on the expected or recorded mobility pattern of the mobile terminal.

13. Method according to any of the preceding claims, wherein the likelihood of successfully connecting the terminal is determined using a measurement report of a further mobile terminal (12) within the reference area.

14. Network node (115) for controlling the selection of a radio access network (101; 102; 103) for establishing a radio connection for connecting a mobile terminal (11) to a communication network (105) wherein the mobile terminal (11) is connectable to the communication network (105) through a plurality of access networks (101; 102; 103), the control node (115) comprising a processing unit (1152) for determining for one or more of the access networks a corresponding likelihood value indicating a likelihood of successfully connecting the mobile terminal to the respective access network with respect to a reference area, and a control unit (1151) for controlling the selection of a radio access network for connecting the mobile terminal using the predetermined likelihood values.

15. Network node according to claim 14, wherein the processing unit is adapted to perform a method of any of the claims 2-13.

16. Mobile terminal (11) for selecting a radio access network (101; 102; 103) for establishing a radio connection for connecting the mobile terminal (11) to a communication network wherein the mobile terminal is connectable to the communication network (105) through a plurality of access networks, the mobile terminal comprising a reception unit (1104) for receiving control information comprising for one or more of the access networks a corresponding likelihood value indicating a likelihood of successfully connecting the mobile terminal to the respective access network with respect to a reference area, and a processing unit (1105) for selecting the radio access network for connecting the mobile terminal using the received control information.
